(19) United States
(12) Patent Application Publication
(10) Pub. No.: US 2012/0046403 A1
(43) Pub. Date: Feb. 23, 2012

(54) AQUEOUS MID-COAT PAINT COMPOSITION

(75) Inventors: Daisuke Tsukuma, Yokohama (JP); Yoshimasa Kamikuri, Yokohama (JP); Shouichi Chida, Yokohama (JP)

(73) Assignee: BASF COATINGS JAPAN LTD., Yokohama (JP)

(21) Appl. No.: 13/263,262

(22) PCT Filed: Mar. 23, 2010
(86) PCT No.: PCT/IB10/00702

§ 371 Date: Oct. 6, 2011

(30) Foreign Application Priority Data
Apr. 19, 2009 (JP) 2009-097778

(51) Int. Cl. C09D 167/00

(52) U.S. Cl. 524/377; 524/539

(57) ABSTRACT

Disclosed is an aqueous mid-coat paint composition comprising a water-soluble or water-dispersible polyester resin (A) having from 2 to 10 mass % of polyethylene glycol groups or polyethylene glycol ether groups of number average molecular weight from 300 to 600; carboxylic acid secondary or tertiary amine salt groups obtained by neutralizing carboxylic acid groups; a total number of from 0.8 to 1.2 of said polyethylene glycol groups or polyethylene glycol ether groups and said carboxylic acid secondary or tertiary amine salt groups per number average molecular weight of the resin; and (B) a melamine resin as curing agent, wherein the ratio by mass of the resin solid fractions of the (A) component and the (B) component is from 75/25 to 90/10.

### TECHNICAL FIELD

The present invention concerns aqueous mid-coat paint compositions which are suitable for automobile purposes and with which it is possible to form paint films with excellent painting operability (especially sag resistance) and which are smooth and provided with good appearance.

### TECHNICAL BACKGROUND

In recent years attention has been focused on aqueous paints in which water is used as a diluent from the viewpoints of atmospheric pollution and the conservation of resources, and mixtures of aminoplast resins and polyester resins which have carboxyl groups are being used in aqueous paints of the bake-curing type. In the automobile mid-coat paint field a high quality appearance which is visually pleasing is required to give a high class feel, and chipping resistance is also required to protect the base material from impacts with small stones and the like, and the quality requirement has increased steadily in recent years, and there is also a demand for paint films which have excellent operability and excellent smoothness with no sag.

Thermally curable aqueous paint compositions in which a film-forming hydrophilic polyester resin or acrylic resin, and curing agent, are dissolved or dispersed in an aqueous medium which contains a neutralizing base which is dissolved or dispersed in an aqueous medium which contains a polyester polyol of acid value less than 40, hydroxyl group value from 50 mgKOH/g to 250 mgKOH/g and number average molecular weight from 500 mgKOH/g to 2,000 mgKOH/g which has been obtained by reacting a mono-epoxy compound with the reaction product of a polyhydric alcohol with three or more functional groups, lactone and polybasic carboxylic acid anhydride are known as aqueous paint compositions which have good painting operability (blistering resistance, sag resistance) which can be used as mid-coat paints (for example see Patent Citation 1). However, a multi-stage process is required to produce the epoxy compounds which are included in the abovementioned thermally curable aqueous paint compositions and the achievement of excellent operability with a simpler means is desirable.

Aqueous mid-coat paints for automobile purposes which contain (A) an aqueous dispersion of a urethane resin with a resin acid value of from 2 to 20 mgKOH/g, (B) a hydroxyl group-containing resin and (C) a crosslinking agent which are characterized in that said aqueous dispersion of a urethane resin (A) has a urethane polymer, which has been obtained by reacting polyisocyanate and polyol having at least two hydroxyl groups in one molecule which includes polyether polyols, polyester polyols and compounds which have at least one carboxyl group and at least two hydroxyl groups and, as required, other polyols, and which has been neutralized with a neutralizing agent, dispersed in a stable manner in an aqueous medium are known as mid-coat paints for automobiles which have excellent chipping resistance, with which no sags are formed in the paint film and which have an excellent finish (for example, see Patent Citation 2). However, the urethane resin is expensive when compared with other resins such as polyesters and the like, and a method for obtaining paint which has excellent coating operability and a good appearance more cheaply is desirable.

Furthermore, aqueous mid-coat paints for automobile purposes which include polyester resin, at least one type of melamine resin, selected from among the group comprising methylol group type melamine resin, imino group type melamine resin and methylol/imino type melamine resin, polyester polyol of number average molecular weight from 400 to 1,500 and a carboxylic acid group containing polymer compound having a specified structure of weight average molecular weight from 50,000 to 1,000,000 are known as mid-coat paints for automobile purposes which have excellent base concealing properties and excellent coating operability with a sag film thickness of 40 μm and above (for example see Patent Citation 3). However, with these paint compositions there is considerable self-condensation of the imino group type melamine resin and methylol type melamine resin which are used and there are cases where the smoothness of the paint film is poor. Furthermore, the self-condensation proceeds while the paint is being stored and there is a problem in that the molecular weight inevitably rises.

### PRIOR ART LITERATURE

### Patent Citations

Patent Citation 1:
Japanese Unexamined Patent Application Laid Open H10-231454
Patent Citation 2:
Japanese Unexamined Patent Application Laid Open 2006-265310
Patent Citation 3:
Japanese Unexamined Patent Application Laid Open 2008-144064

### OUTLINE OF THE INVENTION

### Problems to be Resolved by the Invention

The aim of the present invention is to overcome the disadvantages of the conventional paints described above and to provide an aqueous mid-coat paint composition which has excellent coating operability (especially in terms of sag resistance) and with which it is possible to form paint films which are smooth and of good appearance.

### Means of Resolving These Problems

As a result of thorough research carried out with a view to resolving the aforementioned problems, the inventors have discovered that the amount of carboxylic acid salt in the polyester resin is a factor which affects the sag resistance and that the problem of the dispersibility of the polyester resin in water inevitably falling when the amount of carboxylic acid salt is drastically reduced can be resolved by using a specified polyethylene glycol for at least part of the polyester resin raw material. It has been discovered that the abovementioned problems can be resolved by using this special polyester resin and a defined curing agent, and the invention is based upon this discovery.

That is to say, the present invention provides an aqueous mid-coat paint composition which is characterized in that it contains (A) water-soluble or water-dispersible polyester resin, this being a polyester resin where, within the resin, there are included from 2 to 10 mass % of linear chain or branched chain polyethylene glycol groups or polyethylene glycol ether groups of number average molecular weight from 300 to 600 and in which there are also included carboxylic acid secondary or tertiary amine salt groups which have been obtained by neutralizing at least some of the carboxylic acid groups in the resin, and in which there are a total of from 0.8 to 1.2 of said polyethylene glycol groups or polyethylene glycol ether groups and said carboxylic acid secondary or tertiary amine salt groups per number average molecular weight of the resin, and where the acid value of the polyester resin before said carboxylic acid groups are neutralized with said secondary or tertiary amine is not more than 30 mgKOH/g, the hydroxyl group value is from 90 to 160 mgKOH/g and the number average molecular weight is from 1,300 to 1,900, and (B) melamine resin as curing agent, and the ratio by mass of the resin solid fractions of the (A) component and the (B) component is from 75/25 to 90/10.

Furthermore, the invention provides an aqueous mid-coat paint composition in which, in the abovementioned aqueous mid-coat paint composition, the melamine resin is a fully methylated melamine resin and an imino group-containing type methylated melamine resin, and the proportion of said fully methylated melamine resin with respect to the imino group-containing methylated melamine resin as the ratio by mass of the resin solid fractions is from 100/0 to 50/50.

Furthermore, the invention provides an aqueous mid-coat paint composition in which, in the abovementioned aqueous mid-coat paint composition, the aforementioned paint composition also includes polypropylene glycol or polypropylene glycol ether of number average molecular weight from 400 to 1,200 as a (C) component in an amount of from 1 to 20 mass % of the total resin solid fraction.

Furthermore, the invention provides an aqueous paint composition in which, in the above-mentioned aqueous mid-coat paint composition, the aforementioned paint composition also includes blocked isocyanate compound as a curing agent in an amount of from 1 to 30 mass % of the total resin solid fraction.

### Effect of the Invention

The aqueous mid-coat paints of this invention enable paint films which have a good and smooth appearance to be obtained while retaining good paint film performance in terms of chipping and water resistance for example, and while realizing a high level of painting operability (especially in terms of sag resistance).

### EMBODIMENT OF THE INVENTION

The polyester resins (A) which are used in this invention can be obtained by the esterification reaction of polyfunctional carboxylic acids and/or polyfunctional carboxylic acid anhydrides with polyhydric alcohols, but they are characterized by the fact that linear chain or branched chain polyethylene glycol groups or polyethylene glycol ether groups of number average molecular weight from 300 to 600 are included in the polyester resin as a result of using linear chain or branched chain polyethylene glycol or polyethylene glycol ether of number average molecular weight from 300 to 600 in particular as at least some of the polyhydric alcohol and, furthermore, they are characterized by including carboxylic acid secondary and tertiary amine salts which have been obtained by neutralizing at least some of the carboxylic acid groups in the polyester resin with a secondary or tertiary amine.

Moreover, a polyethylene glycol group is a residual group where one or two or more hydroxyl groups have been removed from a polyethylene glycol, and it may be a polyethylene glycol group which has residual hydroxyl groups where some of the hydroxyl groups have been removed.

Furthermore, a polyethylene glycol ether group is a residual group where one or two or more hydroxyl groups have been have been removed from a polyethylene glycol ether, and it may be a polyethylene glycol ether group which has residual hydroxyl groups where some of the hydroxyl groups have been removed.

With the polyester resin (A), the number average molecular weight of the polyester resin before neutralizing the carboxylic acid groups with secondary or tertiary amine is from 1,300 to 1,900, and preferably from 1,400 to 1,700.

In those cases where the number average molecular of the polyester resin is less than 1,300 it is not possible to obtain satisfactory sag resistance, and in those cases where the number average molecular weight exceeds 1,900 the resin viscosity becomes remarkably high and so the solid fraction is reduced and handling is difficult when preparing a paint.

Furthermore, with the polyester resin (A), the acid value of polyester resin before the carboxylic acid groups are neutralized with secondary or tertiary amine is not more than 30 mgKOH/g, and more desirably not more than 28 mgKOH/g. In those cases where the acid value of the polyester resin exceeds 30 mgKOH/g there is a risk that the stability of the polyester resin aqueous solution (emulsified liquid) will be reduced due to the lowering of the extent of the neutralization of the resin.

Furthermore, in the polyester resin (A), the hydroxyl group value of polyester resin before the carboxylic acid groups are neutralized with secondary or tertiary amine is from 90 to 160 mgKOH/g, and more desirably from 120 to 140 mgKOH/g. In those cases where the hydroxyl group value of the polyester resin is less than 90 mgKOH/g the curability is reduced, and in those cases where it exceeds 160 mgKOH/g there is a risk that the water resistance of the paint film will be reduced.

With the polyester resin (A), no particular limitation is imposed upon the method whereby the polyester resin before the carboxylic acid groups are neutralized with secondary or tertiary amine is synthesized and the synthesis can be carried out in accordance with the usual methods, and the method in which an esterification reaction is carried out with polyfunctional carboxylic acid and/or polyfunctional carboxylic acid anhydride and polyhydric alcohol and the like as the reaction components by heating under a nitrogen atmosphere to from 100 to 250° C. for from 6 to hours can be cited as an example. The abovementioned reaction components may be added and reacted in one shot, or some of each reaction component may be added and reacted and then the remaining reaction components may be added and reacted in a multi-stage reaction. Furthermore, a catalyst which promotes the esterification may be used at this time.

The polyfunctional carboxylic acid is a compound where there are two or more carboxyl groups in one molecule, and the polybasic acids generally used for the production of polyesters such as, for example, phthalic acid, isophthalic acid, hexahydrophthalic acid, hexahydroisophthalic acid, tetrahydroterephthalic acid, hexahydrophthalic acid, hexahydro-isophthalic acid, hexahydroterephthalic acid, trimellitic acid, adipic acid, sebacic acid, succinic acid, azeleic acid, naphthalenedicarboxylic acid, 4,4-diphenyldicarboxylic acid, hettic acid, fumaric acid, maleic acid, itaconic acid, pyromellitic acid and the like. Also fatty acids which have from 8 to 18 carbon atoms, dimer acid and the like can be used. These can be used individually, or a combination of two or more types can be used. The polyfunctional carboxylic acid anhydrides are compounds where there is one or more acid anhydride groups in one molecule and, for example, the anhydrides of the abovementioned polyfunctional carboxylic acids and the like can be used. These can be included with the abovementioned polyfunctional carboxylic acids and they can be used individually or a combination of two or more types can be used.

The polyhydric alcohols are compounds where there are two or more hydroxyl groups in one molecule and, for example, glycols such as ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butylene glycol, 1,4-butanediol, 1,5-pentanediol, 1,6-hexanediol, 2-butyl-2-ethyl-1,3-propanediol, methylpropanediol, cyclohexanedimethanol, 3,3-diethyl-1,5-pentanediol and the like, and also polyols with three or more hydroxyl groups, for example glycerine, trimethylolethane, trimethylolpropane, pentaerythritol, dipentaerythritol and the like, for maintaining the balance of processability and hardness of the paint film, are preferably used. These polyhydric alcohols can be used individually or a combination of two or more types can be used.

A distinguishing feature of the polyester resin (A) is that there are included within the polyester resin from 2 to 10 mass %, preferably from 2 to 8 mass %, and more desirably from 4 to 6 mass %, of linear chain or branched chain polyethylene glycol groups or polyethylene glycol ether groups of number average molecular weight from 300 to 600.

Moreover, either polyethylene glycol groups or polyethylene glycol ether groups may be present in the polyester resin (A), or groups of both types may be present. In those cases where both types of group are present, the abovementioned polyethylene glycol group or polyethylene glycol ether group content in the polyester (A) is the content in total of both types.

If the proportion of the above-mentioned polyethylene glycol groups or polyethylene glycol ether groups included in the polyester resin (A) is less than 2 mass % then there is a risk that adequate water solubility or water dispersibility will not be imparted to the polyester resin, and if the content exceeds 10 mass % then there is a risk that the hardness of the paint film obtained will be reduced.

The introduction of the above-mentioned polyethylene glycol groups or polyethylene glycol ether groups into the polyester resin (A) can be carried out by esterification using a linear chain or branched chain polyethylene glycol or polyethylene glycol ether of number average molecular weight from 300 to 600 as a raw material polyhydric alcohol.

The linear chain or branched chain polyethylene glycol or polyethylene glycol ethers of number average molecular weight from 300 to 600 which can be used to produce the polyester resin (A) include, for example, commercial products such as PEG #300, PEG #400, PEG #600 (polyethylene glycols, trade names, produced by the Nippon Oil and Fat Co.), and Uniox G-450 (polyoxyethylene glyceryl ether, trade name, produced by the Nippon Oil and Fat Co.) and the like.

The branched chain polyethylene glycol ethers can be produced, for example, by the addition polymerization of ethylene oxide in the presence of an alcohol with three or more alcoholic hydroxyl groups. Glycerine, trimethylolethane, trimethylolpropane, pentaerythritol, dipentaerythritol and the like can be cited as examples of the alcohol which has three or more alcoholic hydroxyl groups.

In those cases where the number average molecular weight of the linear chain or branched chain polyethylene glycol or polyethylene glycol ether is less than 300 there is a risk that it will not be possible to provide the polyester resin with satisfactory water solubility or water dispersibility, and in those cases where the number average molecular weight exceeds 600 it may again not be possible to provide the polyester resin with satisfactory water solubility or water dispersibility, and there is also a risk that the hardness of the paint film obtained may be reduced.

Furthermore, another distinguishing feature of the polyester resin (A) is that it includes carboxylic acid secondary or tertiary amine salt groups obtained by neutralizing at least some of the carboxylic acid groups in the resin with a secondary or tertiary amine.

Examples of the secondary and tertiary amines for neutralizing the carboxylic acid groups in the polyester resin for the polyester resin (A) include either one amine or a mixture of amines having secondary or tertiary amino groups, including alkanolamines such as dimethylolamine and tri-ethanolamine, alkylamines such as diethylamine and triethylamine, alkylalkanolamines such as dimethyl-ethanolamine and the like, morpholines such as morpholine and N-methylmorpholine, and the like. From among these, preference is given to dimethanolamine, triethanolamine, diethylethanolamine, morpholine and N-methylmorpholine since they are soluble in water.

Furthermore, the reason why primary amine compounds are not used in this invention is because primary amine compounds are highly reactive in many cases and reduce the storage stability of the paint and cause problems such as yellowing of the paint film.

Furthermore, the total number of carboxylic acid amine salt groups when the carboxylic acid groups in the polyester resin have been neutralized with secondary or tertiary amine and linear chain or branched chain polyethylene glycol groups or polyethylene glycol ether groups of number average molecular weight from 300 to 600 in the polyester resin (A) is from 0.8 to 1.2, and preferably from 0.9 to 1.1, per number average molecular weight of the polyester resin.

Moreover, either carboxylic acid secondary amine salt groups or carboxylic acid tertiary amine salt groups may be present in the polyester resin (A), or both of these types of salt group may be present. In those cases where both types are present the number of carboxylic acid secondary or tertiary amine salt groups in the polyester resin (A) is the total number of both types of salt group.

Furthermore, the number of linear chain or branched chain polyethylene glycol groups or polyethylene glycol ether groups in the polyester resin (A) is the total number of both types of group in those cases where both types of group are present.

By controlling the total number of carboxylic acid amine salt groups and polyethylene glycol groups or ethylene glycol ether groups in the way indicated above in the polyester resin (A) it is possible to impart water solubility or water dispersibility to the polyester resin while obtaining good sag resistance. If the total number is outside the range indicated above then it is difficult to achieve these effects.

In those cases where the total number of the abovementioned carboxylic acid amine salt groups and linear chain or branched chain polyethylene glycol groups or polyethylene glycol ether groups of number average molecular weight from 300 to 600 is less than 0.8 per number average molecular weight of the polyester resin, adequate water solubility or water dispersibility is not imparted to the polyester resin, and in those cases where it exceeds 1.2 there is a risk that the water resistance of the paint film obtained will become poor.

In this invention the polyester resin (A) has water solubility or water dispersibility and it is dissolved or dispersed in the aqueous medium of the aqueous mid-coat paint composition.

The aqueous mid-coat paint compositions of this invention include a melamine resin as the hardening agent of the (B) component.

Fully alkyl type melamine resins which have a different type of reactive group, methylol type melamine resins, imino group-containing type melamine resins and mixtures of these resin types can be cited as examples of the melamine resin. From among these, the fully alkyl type melamine resins, imino group-containing type melamine resins and mixtures of these types are preferred. The fully methylated melamine resins are preferred for the fully alkyl type melamine resin, and the imino group-containing methylated melamine resins are preferred for imino group-containing type melamine resin.

The high methylol type melamine resins have pronounced self-condensation properties and may lower the paint storage stability, and a self-condensed layer of melamine resin is formed on the paint film surface and defects such as unevenness due to volume contraction are liable to appear, and these defects cannot be overcome even if a fully methylated melamine resin is used conjointly.

The ratio of fully methylated melamine resin compounded with respect to the imino group-containing type methylated melamine resin used is preferably in the proportions of from 100/0 to 50/50 in terms of the resin solid fraction mass ratio. Proportions of from 95/5 to 60/40 are preferred, and proportions of from 90/10 to 65/35 are more desirable.

Furthermore when, in those cases where imino group-containing type methylated melamine resin is used conjointly, the proportion of imino group-containing type methylated melamine resin with respect to the fully methylated melamine resin exceeds 50 mass % there is pronounced self-condensation, in the same way as with the methylolated melamine resins, and satisfactory paint film smoothness is not obtained.

Luwipal L066 (produced by the BASF Co.) and Cymel 300, Cymel 301, Cymel 303 and Cymel 350 (all produced by the Nihon Cytec Industries Co.) can be cited as fully alkyl-type melamine resins. One of these may be used individually, or a combination of two or more types can be used.

Furthermore, Cymel 325, Cymel 327 (both produced by the Nihon Cytec Industries Co.) and the like can be cited as examples of the imino group-containing type methylated melamine resin.

The amount of melamine resin included as the curing agent (B) component in an aqueous mid-coat paint composition of this invention as the resin solid fraction mass ratio of polyester resin with respect to melamine resin is from 75/25 to 90/10, and more desirably from 77/23 to 85/15. In those cases where the amount of polyester resin as the mass ratio of the resin solid fractions is greater than 90/10 the curability declines, and in those cases where it is less than 75/25 the performance in terms of chipping resistance, blistering and the like of the paint film obtained declines. Melamine resins other than those mentioned above may be included in small amounts provided that the amount is such that there is no loss of paint film performance.

Blocked isocyanate compounds may be included as well as the fully alkyl type melamine resin as curing agents in an aqueous mid-coat paint composition of this invention in order to improve properties such as chipping resistance and the like. The blocked isocyanate compounds are preferably included in an amount of from 1 to 30 mass % of the total resin component. The blocked isocyanate compounds are preferably included in an amount of from 1 to 30 mass %, more desirably of from 3 to 20 mass %, and most desirably of from 5 to 15 mass %, of the total resin component. In those cases where the amount of blocked isocyanate compound included is less than 1 mass % of the whole resin component there is no performance improving effect, and in those cases where the amount included exceeds 30 mass % there is a risk that crosslinking will inevitably be sparse. Furthermore, the blocked isocyanate compounds are expensive and so the addition of just a small amount is more desirable from the point of view of the cost.

Bayhydur BL 5140, Bayhydur VPLS 2240, Bayhydur VPLS 2310 (all produced by the Sumitomo Bayer Urethane Co.) and the like can be cited as examples of the abovementioned blocked isocyanate compounds. One of these may be used individually, or a combination of two or more types can be used.

The inclusion of linear chain or branched chain polypropylene glycol or polypropylene glycol ether in an amount of from 1 to 20 mass %, and preferably in an amount of 3 to 10 mass %, of the total resin component in an aqueous mid-coat paint composition of this invention is desirable for raising the solid fraction of the paint and improving the paint deposition efficiency and also for controlling the flow properties and improving the appearance.

The polypropylene glycol ether may be a monohydric alcohol, but it may be a polyhydric alcohol.

Moreover, either a linear chain or branched chain polypropylene glycol or a linear chain or branched chain polypropylene glycol ether may be used, or both may be used conjointly. In those cases where both are used conjointly the amount of linear chain or branched chain polyethylene glycol or polyethylene glycol ether included is the whole amount of the two which are included.

The preferred number average molecular weight of the linear chain or branched chain polypropylene glycol or polypropylene glycol ether is from 400 to 1,200, and more desirably the number average molecular weight is from 600 to 1,000. In those cases where the number average molecular weight is less than 400 little of the polypropylene glycol or polypropylene glycol ether remains as solid fraction in the paint film, and if it exceeds 1,200 then the polypropylene glycol or polypropylene glycol ether itself inevitably becomes insoluble in water.

In those cases where the amount of linear chain or branched chain polypropylene glycol or polypropylene glycol ether included is less than 1 mass % of the whole resin component there is no controlling effect on the flow properties due to the addition of the linear chain or branched chain polypropylene glycol or polypropylene glycol ether, and in those cases where the amount of linear chain or branched chain polypropylene glycol or polypropylene glycol ether included is more than 20 mass % of the whole resin component there is a risk that the paint film hardness will be reduced.

Uniol D-700 (trade name, produced by the Nippon Oil and Fat Co., polypropylene glycol, average molecular weight 700), Uniol TG-1000 (trade name, produced by the Nippon Oil and Fat Co., polyoxypropylene glyceryl ether, average molecular weight 1,000) and the like can be cited as examples of the abovementioned polypropylene glycol or polypropylene glycol ether.

Pigments can be included in the aqueous mid-coat paint compositions of this invention for coloring purposes, for improving the base concealing properties and paint stability, and for raising various aspects of the performance of the paint films obtained. Examples of the abovementioned pigments include colored pigments such as chrome yellow, yellow iron oxide, iron oxide, carbon black, titanium dioxide, azo-chelate-based pigments, insoluble azo-based pigments, condensed azo-based pigments, phthalocyanine-based pigments, indigo pigments, perinone-based pigments, perylene-based pigments, dioxane-based pigments, quinacridone-based pigments, isoindolinone-based pigments, metal complex pigments and the like, and true pigments such as calcium carbonate, precipitated barium sulfate, clay, talc and the like.

In those cases where the abovementioned pigments are included in an aqueous mid-coat paint composition of this invention the value indicated by total pigment mass/total resin solid fraction mass is preferably from 0.25 to 1.5, and more desirably from 0.5 to 1.2. In those cases where the abovementioned value is less than 0.25 there is a risk that color design of the paint will become difficult, and in those cases where it exceeds 1.5 there is a risk that the chipping resistance will be reduced.

The aqueous mid-coat paint compositions of this invention can include, as well as the above-mentioned components, the polyurethane resins, organic solvents, curing catalysts, surface controlling agents, antifoaming agents, film-forming aids, ultraviolet absorbers, antioxidants and the like known to those in the industry, as required.

No particular limitation is imposed upon the method whereby the aqueous mid-coat paint compositions of this invention are obtained, and all of the methods known to those in the industry such as milling a mixture of the abovementioned resins and pigments etc. and dispersion using a ball mill or sand mill or a Disper or the like can be used.

The aqueous mid-coat paint compositions of this invention can be provided for painting as they are or after being diluted to an appropriate viscosity with water or, depending on the case, with a small amount of organic solvent or amine. The methods used with mid-coat paints in the automobile industry generally, for example air-sprayer painting, airless-sprayer painting, air-atomization type electrostatic painting, bell rotation atomization type electrostatic painting and the like, can all be used as painting methods.

With the aqueous mid-coat paint compositions of this invention, the cured paint films are obtained by applying the composition in such a way as to provide a film thickness after curing of from 10 to 60 μm on an automobile body which has been subjected to undercoat painting with electro-deposition paint or sealing material or the like beforehand and then heating and drying for from 10 minutes to 1 hour at a temperature of from 120 to 180° C.

### Illustrative Examples

The invention is described in more detail below by means of illustrative examples, but the invention is not limited by these illustrative examples. Moreover, when there is no indication to the contrary the terms “parts”, “%” and “proportions” indicate “parts by mass”, “mass %” and “proportions by mass” respectively.

### Production Example 1

### Production of Polyester Resin Aqueous Solution A

13.6 parts of Trimethylolethane, 9.6 parts of tetrahydrophthalic acid anhydride, 5 parts of polyoxyethylene glyceryl ether (trade name Uniox G450, produced by the Nippon Oil and Fat Co., number average molecular weight 450) as a branched chain polyethylene glycol, 36.8 parts of phthalic acid anhydride and 30.6 parts of 3-methyl-1,5-pentanediol were introduced into a reactor which had been furnished with a reflux tube packed with stainless steel packing material and fitted with a Dean and Stark trap, a thermometer and stirring apparatus and the temperature was raised to 150° C. and then to 230° C. over a period of 3.5 hours and a dehydration/condensation reaction was carried out until the resin acid value fell below 10 mgKOH/g, after which the reaction temperature was reduced to 140° C., 4.4 parts of pyromellitic acid anhydride were added and, after the pyromellitic acid anhydride had been dissolved, the temperature was raised to 180° C. and maintained at 180° C. and the reaction continued. When the resin acid value reached the set acid value of 28 the reaction temperature was reduced to 120° C. and 10 parts of butyl cellosolve were added. The acid value of the polyester resin obtained was 28 mgKOH/g, the hydroxyl group value was 140 mgKOH/g and the number average molecular weight by GPC calculated as polystyrene was 1,600. Then, after being cooled to room temperature, 4.2 parts of dimethylethanolamine were added slowly, with stirring, and, after stirring thoroughly, 176.5 parts of de-ionized water were added and the mixture was stirred thoroughly and the polyester resin aqueous solution A (emulsified liquid A) was obtained. The residue on heating the polyester resin aqueous solution A was 33.0 mass %.

### Production Examples 2 to 8

### Production of Polyester Resin Aqueous Solutions B to H>

The polyester resin aqueous solutions B to H were obtained in the same way as in Production Example 1 except that the raw materials were changed as shown in Table 1. However, the set acid value differed according to the resin. The property values for the polyester resins obtained were as shown in Table 1.

TABLE 1

| Polyester Resin Aqueous Solution | | A | B | C | D | E | F | G | H |
|---|---|---|---|---|---|---|---|---|---|
| Trimethylolethane | | 13.6 | 13.6 | 13.6 | 13.6 | 13.6 | 13.6 | 13.6 | 13.6 |
| Tetrahydrophthalic acid anhydride | | 9.6 | 9.6 | 9.6 | 9.6 | 5.0 | 9.6 | 9.6 | 9.6 |
| Uniox G450 *1 | | 5.0 | 5.0 | 5.0 | 9.0 | 5.0 | 5.0 | | 5.0 |
| PEG #800 *2 | | | | | | | | 15.0 | |
| Phthalic acid anhydride | | 36.8 | 36.1 | 39.5 | 37.8 | 42.9 | 34.5 | 32.7 | 39.9 |
| 3-Methyl-1,5-pentanediol | | 30.6 | 31.1 | 30.3 | 28.0 | 40.5 | 31.3 | 25.4 | 29.0 |
| Pyromellitic acid anhydride | | 4.4 | 4.6 | 2.0 | 2.0 | 1.6 | 6.0 | 3.7 | 2.9 |
| DMEA | | 4.2 | 3.0 | 4.2 | 3.0 | 6.0 | 3.0 | 4.2 | 4.2 |
| Butyl cellosolve | | 10.0 | 10.0 | 10.0 | 10.0 | 10.0 | 10.0 | 10.0 | 10.0 |
| De-ionized water | | 176.5 | 177.7 | 176.5 | 177.7 | 174.7 | 177.7 | 176.5 | 176.5 |
| Total Amount Introduced | | 290.7 | 290.7 | 290.7 | 290.7 | 290.7 | 290.7 | 290.7 | 290.7 |
| Acid Value (mgKOH/g) | | 28 | 20 | 28 | 20 | 40 | 20 | 28 | 28 |
| Hydroxyl Group Value (mgKOH/g) | | 140 | 140 | 140 | 140 | 140 | 140 | 140 | 140 |
| Residue on Heating (mass %) | | 33.0 | 33.0 | 33.0 | 33.0 | 33.0 | 33.0 | 33.0 | 33.0 |
| Number Average Molecular Weight | | 1,600 | 1,850 | 1,350 | 1,600 | 800 | 2,100 | 1,600 | 1,600 |
| Total Number of PEG Groups or PEGE Groups | | 0.98 | 1.13 | 0.82 | 0.89 | 0.66 | 1.09 | 1.10 | 1.20 |
| and Secondary or Tertiary Amine Salt Groups | | | | | | | | | |
| per Number Average Molecular Weight of the | | | | | | | | | |
| Polyester Resin | | | | | | | | | |
| PEG Group | Number Average Molecular | 450 | 450 | 450 | 450 | 450 | 450 | 800 | 200 |
| or PEGE | Weight | | | | | | | | |
| Group | Amount Included (mass %) | 5.0 | 5.0 | 5.0 | 9.0 | 5.0 | 1.0 | 15.0 | 5.0 |

### Notes for the Numbered Items in Table 1

*1: Uniox G450 (trade name, produced by the Nippon Oil and Fat Co., polyoxyethylene glyceryl ether=branched chain polyethylene glycol ether, number average molecular weight 450)
*2: PEG #800 (Trade name, produced by the Nippon Oil and Fat Co., linear chain type polyethylene glycol, number average molecular weight 800)

### Example 1

### Production of an Aqueous Mid-Coat Paint Composition

The polyester resin aqueous solution A (57.4 parts), 11.7 parts of de-ionized water, 1.9 parts of titanium oxide, 19.9 parts of barium sulfate, 1.4 parts of talc and 0.9 parts of carbon black were introduced into a dispersion vessel and dispersed until the particle size was 10 μm or below to prepare a paint paste. Then, fully methylated melamine resin (trade name Cymel 303, produced by the Nihon Cytec Industries Co., residue on heating 100 mass %) (3.3 parts), 1.4 parts of methyl/butyl mixed etherified melamine resin (trade name Cymel 325, produced by the Nihon Cytec Industries Co., residue on heating 80 mass %) and 0.8 part of polyoxypropylene glyceryl ether (trade name Uniol TG-1000, produced by the Nippon Oil and Fat Co., number average molecular weight 1,000) as polypropylene glycol were added and, after stirring to provide a uniform mixture, 1.3 parts of blocked polyisocyanate compound (trade name Bayhydur VPLS2310, produced by the Sumika Bayer Urethane Co., involatile fraction 39.5 mass %, effective NCO 3.9 mass %) were added and the mixture was stirred until uniform and an aqueous mid-coat paint composition was obtained.

### Examples 2 to 9 and Comparative Examples 1 to 6

### Production of Aqueous Mid-Coat Paint Compositions

Aqueous mid-coat paint compositions with the formulations shown in Table 2 and Table 3 were obtained in the same way as in Example 1.

TABLE 2

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Polyester Resin Aqu. Sol. A | | 57.4 | | | | 56.4 | | 55.3 | 58.1 |
| Polyester Resin Aqu. Sol. B | | | 56.7 | | | | | | |
| Polyester Resin Aqu. Sol. C | | | | 56.5 | | | | | |
| Polyester Resin Aqu. Sol. D | | | | | 58.3 | | 58.0 | | |
| Polyester Resin Aqu. Sol. E | | | | | | | | | |
| Polyester Resin Aqu. Sol. F | | | | | | | | | |
| Polyester Resin Aqu. Sol. G | | | | | | | | | |
| Polyester Resin Aqu. Sol. H | | | | | | | | | |
| Fully Alkyl Type Melamine *3 | | 3.3 | 3.3 | 3.3 | 3.4 | 3.9 | 3.3 | 3.2 | 3.4 |
| Imino Group-containing Melamine *4 | | 1.4 | 1.4 | 1.4 | 1.4 | 1.7 | 1.4 | 1.4 | 1.4 |
| Polypropylene Glycol Ether (Number | | 0.8 | 0.8 | 2.1 | 0.7 | 0.1 | | 4.1 | |
| average mol. weight 1,000) *5 | | | | | | | | | |
| Polypropylene Glycol Ether (Number | | | | | | | | | 0.7 |
| average mol. weight 330) *6 | | | | | | | | | |
| De-ionized Water | | 11.7 | 11.4 | 11.6 | 11.7 | 13.3 | 11.6 | 11.3 | 11.9 |
| Blocked Isocyanate *7 | | 1.3 | 2.6 | 1.3 | | | 1.3 | 1.4 | |
| Titanium Dioxide | | 1.9 | 1.9 | 1.9 | 1.9 | 1.9 | 1.9 | 1.8 | 1.9 |
| Barium Sulfate | | 19.9 | 19.6 | 19.6 | 20.2 | 20.3 | 20.1 | 19.2 | 20.1 |
| Talc | | 1.4 | 1.4 | 1.4 | 1.4 | 1.4 | 1.4 | 1.4 | 1.4 |
| Carbon Black | | 0.9 | 0.9 | 0.9 | 1.0 | 1.0 | 1.0 | 0.9 | 1.0 |
| TOTAL | | 100.0 | 100.0 | 100.0 | 100.0 | 100.0 | 100.0 | 100.0 | 100.0 |
| Acid Value (mgKOH/g) | | 28 | 20 | 28 | 20 | 28 | 20 | 28 | 28 |
| Hydroxyl Group Value (mgKOH/g) | | 140 | 140 | 140 | 140 | 140 | 140 | 140 | 140 |
| Number Average Mol. Weight | | 1,600 | 1,850 | 1,350 | 1,600 | 1,600 | 1,600 | 1,600 | 1,600 |
| Total Number of PEG Groups or PEGE | | 0.98 | 1.13 | 0.82 | 0.89 | 0.98 | 0.89 | 0.98 | 0.98 |
| Groups | | | | | | | | | |
| and Secondary or Tertiary Amine Salt | | | | | | | | | |
| Groups per No. Average Molecular | | | | | | | | | |
| Weight of the Polyester Resin | | | | | | | | | |
| PEG-Type | No. Average Mol. | 450 | 450 | 450 | 450 | 450 | 450 | 450 | 450 |
| Groups | Weight | | | | | | | | |
| | Amount Inc. (mass %) | 5 | 5 | 5 | 9 | 5 | 9 | 5 | 5 |
| Melamine | Mass Ratio (PES/MF) | 80/20 | 80/20 | 80/20 | 80/20 | 77/23 | 80/20 | 80/20 | 80/20 |
| Resin | Mass Ratio (fully | 70/30 | 70/30 | 70/30 | 70/30 | 70/30 | 70/30 | 70/30 | 70/30 |
| | alkyl- type/other | | | | | | | | |
| | type | | | | | | | | |
| PPG-Type | No. Average Mol. | 1,000 | 1,000 | 1,000 | 1,000 | 1,000 | — | 1,000 | 350 |
| | Weight | | | | | | | | |
| | Amount Inc. (mass %) | 3 | 3 | 8 | 3 | 0.5 | 0 | 15 | 3 |
| Blocked Isocyanate Content in Whole | | 5.0 | 10 | 5.0 | 0 | 0 | 5.0 | 5.0 | 0 |
| Resin Component (mass %) | | | | | | | | | |
| Items | Sag | ⊚ | ⊚ | ◯ | ⊚ | ⊚ | ⊚ | ⊚ | ◯ |
| Evaluated | Blistering | ◯ | ◯ | ◯ | ◯ | Δ | ◯ | ◯ | ◯ |
| | Appearance | ◯ | Δ | ◯ | ◯ | ◯ | Δ | ◯ | ◯ |
| | Post-water resistance | ◯ | ◯ | ◯ | Δ | ◯ | Δ | ◯ | ◯ |
| | adhesion | | | | | | | | |
| | Chipping | ◯ | ◯ | ◯ | ◯ | Δ | ◯ | ◯ | ◯ |
| | Paint film hardness | ◯ | ◯ | ◯ | Δ | ◯ | Δ | Δ | ◯ |

TABLE 3

| | | Comp. | Comp. | Comp. | Comp. | Comp. | Comp. |
|---|---|---|---|---|---|---|---|
| | | Ex. 1 | Ex. 2 | Ex. 3 | Ex. 4 | Ex. 5 | Ex. 6 |
| Polyester Resin Aqueous Solution A | | | | | 43.9 | 68.6 | |
| Polyester Resin Aqueous Solution B | | | | | | | |
| Polyester Resin Aqueous Solution C | | | | | | | |
| Polyester Resin Aqueous Solution D | | | | | | | |
| Polyester Resin Aqueous Solution E | | 57.9 | | | | | |
| Polyester Resin Aqueous Solution F | | | 57.5 | | | | |
| Polyester Resin Aqueous Solution G | | | | 57.3 | | | |
| Polyester Resin Aqueous Solution H | | | | | | | 58.1 |
| Fully Alkyl-type Melamine *3 | | 3.3 | 3.3 | 3.3 | 6.8 | 0.8 | 2.9 |
| Imino Group-containing Melamine *4 | | 1.4 | 1.4 | 1.4 | 2.9 | 0.4 | 1.9 |
| Polypropylene Glycol Ether (Number average mol. | | 0.7 | 0.8 | 0.8 | 0.8 | 0.7 | 0.7 |
| weight 1,000) *5 | | | | | | | |
| Blocked Isocyanate *7 | | | 1.3 | 1.3 | | | |
| De-ionized Water | | 12.2 | 11.5 | 11.7 | 21.1 | 5.1 | 11.9 |
| Titanium Dioxide | | 1.9 | 1.9 | 1.9 | 1.9 | 1.9 | 1.9 |
| Barium Sulfate | | 20.1 | 19.9 | 19.9 | 20.3 | 20.0 | 20.1 |
| Talc | | 1.4 | 1.4 | 1.4 | 1.4 | 1.4 | 1.4 |
| Carbon Black | | 1.0 | 0.9 | 0.9 | 1.0 | 1.0 | 1.0 |
| TOTAL | | 100.0 | 100.0 | 100.0 | 100.0 | 100.0 | 100.0 |
| Acid Value (mgKOH/g) | | 40 | 20 | 28 | 28 | 28 | 28 |
| Hydroxyl Group Value (mgKOH/g) | | 140 | 140 | 140 | 140 | 140 | 140 |
| Number Average Molecular Weight | | 800 | 2,100 | 1,600 | 1,600 | 1,600 | 1,600 |
| Total Number of PEG Groups or PEGE Groups and | | 0.66 | 1.09 | 1.10 | 0.98 | 0.98 | 1.20 |
| Secondary or Tertiary Amine Salt Groups per No. | | | | | | | |
| Average Molecular Weight of the Polyester Resin | | | | | | | |
| PEG-Type | No. Average Mol. Weight | 450 | 450 | 800 | 450 | 450 | 200 |
| Groups | Amount Inc. (mass %) | 5 | 1 | 15 | 5 | 5 | 5 |
| Melamine | Mass Ratio (PES/MF) | 80/20 | 80/20 | 80/20 | 60/40 | 95/5 | 80/20 |
| Resin | Mass Ratio (Fully alkyl-type/other | 70/30 | 70/30 | 70/30 | 70/30 | 70/30 | 40/60 |
| | type) | | | | | | |
| PPG-Type | No. Average Mol. Weight | 1,000 | 1,000 | 1,000 | 1,000 | 1,000 | 1,000 |
| | Amount Inc. (mass %) | 3 | 3 | 3 | 3 | 3 | 3 |
| Block Isocyanate Content in Whole Resin Component | | 0 | 5.0 | 5.0 | 0 | 0 | 0 |
| (mass %) | | | | | | | |
| Items | Sag | X | ⊚ | X | ⊚ | ⊚ | X |
| Evaluated | Blistering | ◯ | ◯ | ◯ | X | ◯ | ◯ |
| | Appearance | ◯ | X | ◯ | Δ | ◯ | X |
| | Post-water resistance adhesion | ◯ | ◯ | Δ | ◯ | ◯ | ◯ |
| | Chipping | ◯ | ◯ | ◯ | X | Δ | Δ |
| | Paint film hardness | ◯ | ◯ | X | ◯ | X | ◯ |

### Notes for the Numbered Items in Tables 2 and 3

*3: Cymel 303 (trade name, produced by the Nihon Cytec Industries Co., fully methylated melamine resin, residue on heating 100 mass %)
*4: Cymel 325 (trade name, produced by the Nihon Cytec Industries Co., imino group-containing methylated melamine resin, residue on heating 80 mass %)
*5: Uniol TG-1000 (trade name, produced by the Nippon Oil and Fat Co., polyoxypropylene glyceryl ether=branched chain polypropylene glycol ether, number average molecular weight 1,000)
*6: Uniol TG-330 (trade name, produced by the Nippon Oil and Fat Co., polyoxypropylene glyceryl ether=branched chain polypropylene glycol ether, number average molecular weight 330)
*7: Bayhydur VPLS 2310 (trade name, produced by the Sumika Bayer Urethane Co., blocked polyisocyanate compound, involatile fraction δ9.5 mass %, effective NCO 3.9 mass %)

Moreover, the following abbreviations are used in Tables 1, 2 and 3.

PEG: Polyethylene glycol
PEGE: Polyethylene glycol ether

### PEG-Type: PEG or PEGE

PPG: Polypropylene glycol
PPGE: Polypropylene glycol ether

### PPG-Type: PPG or PPGE

### PES: Polyester

### DMEA: Dimethylethanolamine

MF: Melamine resin

The evaluation of paint films of the examples and comparative examples was carried out using the methods outlined below.

### <Paint Film Evaluation Methods>

A sheet obtained by electro-deposition painting a cationic electro-deposition paint (trade name Canguard 500, produced by the BASF Coatings Japan Co.) in such a way as to provide a dry film thickness of from 15 to 20 μm on a steel sheet (JIS G 3141, thickness 0.8 mm, length 450 mm, width 100 mm) which had been subjected to a chemical forming treatment with a chemical forming agent (trade name Bondrite No. 3004, produced by the Japan Parkerizing Co., a zinc phosphate-based film-forming treatment agent) was used as a test base material (object for painting) for carrying out paint film evaluation tests. Moreover, a base material in which punched holes of diameter 5 mm had been opened up over 4 cm parallel to the length direction of the steel plate beforehand was used just for the evaluation of sag resistance.

Furthermore, the aqueous mid-coat paints were diluted with de-ionized water in such a way that the viscosity with a Ford cup No. 4 was 50 seconds (20° C.) and then used for painting.

### <1> Sag Resistance

Gradient application of the aqueous mid-coat paint composition was carried out in such a way that the dry film thickness gradually increased from 20 to 60 μm using a rotary atomization type bell painting machine (produced by the ABB Industry Co., trade name Metallic Bell G1-COPES Bell). Furthermore, the painting was carried out in a state where the test base material was perpendicular to the ground surface. After being left to stand for 7 minutes at room temperature, flash-off was carried out for 3 minutes at 80° C. in an electric hot draught drier and then the film was baked for 30 minutes at 140° C. and observed, and the sag resistance was evaluated in the following way by measuring the film thickness where the distance from the bottom of a punched hole to the tip of the sag was 5 mm.

[symbol]

: More than 45 μm
◯: 45 μm to 40 μm
Δ: Less than 40 μm to 35 μm
X: Less than 35 μm

### <2> Blistering Properties

Gradient application of the aqueous mid-coat paint composition was carried out in such a way that the dry film thickness gradually increased from 20 to 60 μm using a rotary atomization type bell painting machine (produced by the ABB Industry Co., trade name Metallic Bell G1-COPES Bell). Furthermore, the painting was carried out in a state where the test base material was perpendicular to the ground surface. After being left to stand for 7 minutes at room temperature, flash-off was carried out for 3 minutes at 80° C. in an electric hot draught drier and then the film was baked for 30 minutes at 140° C. and observed, and the film thickness at which blistering occurred was measured and evaluated in the following way.

◯: More than 40 μm
Δ: less than 40 μm to 35 μm
X: Less than 35 μm

### <3> Appearance

Painting was carried out with the aqueous mid-coat paint composition in such a way that the dry film thickness was 25 μm using a rotary atomization type bell painting machine (produced by the ABB Industry Co., trade name Metallic Bell G1-COPES Bell). After application, the sample was left to stand for 7 minutes at room temperature and flash-off was carried out for 3 minutes at 80° C. in an electric hot draught drier and then the film was baked for 30 minutes at 140° C. and observed and the appearance of the painted sheet obtained was evaluated visually in the following way.

### ◯: Good

A: Rather poor (rounding)
X: Poor (grainy, orange peel)

### <4> Warm Water Resistance

The aqueous mid-coat paint composition was air-sprayer painted in such a way as to provide a dry film thickness of 25 μm and, after being left to stand for 7 minutes at room temperature, flash-off was carried out for 3 minutes at 80° C. in an electric hot draught drier and then the film was baked for 30 minutes at 140° C. Then, an aqueous colored base coat paint (trade name Aqua BC-3, produced by the BASF Coatings Japan Co., silver colored) was air-sprayer coated in such a way as to provide a dry film thickness of 15 μm and, after setting for 3 minutes at room temperature, the film was flashed off for 10 minutes at 80° C. After being left to cool back down to room temperature, a clear coat paint (trade name Belcoat No. 6100, produced by the BASF Coatings Japan Co.) was air-sprayer coated in such a way as to provide a dry film thickness of 30 μm and baked for 30 minutes at 140° C. The painted sheet was immersed in warm water at 40° C. for 10 days and then one hundred 2 mm squares were formed in a block using a cutter knife and a peeling test was carried out using cellophane tape. The number of residual squares which had not been peeled away was counted and an evaluation was made in the following way.

◯: No peeling, proportion of squares remaining 100/100
Δ: 100/100 (with lines missing)
X: Less than 100/100

### <5> Chipping Resistance

A painted sheet with an aqueous colored base coat paint and clear coat paint over painted on the aqueous mid-coat paint was made in the same way as in the warm water resistance test. This painted sheet was cooled to −20° C. and then set in a Gravello tester in such a way that the stones where thrown from the nozzle perpendicular to the painted sheet from a distance of 30 cm from the center of the painted sheet. Then 50 g of No. 7 crushed stone (Basalt) were blown onto the painted sheet with air at 0.2 MPa. After the test the peeling part of the painted sheet was stripped completely with tape and the extent of peeling was evaluated visually in the following way.

◯: No peeling which reached the base material was seen
Δ: Slight peeling which reached the base material was seen
X: Extensive peeling which reached the base material was seen

### <6> Paint Film Hardness

The aqueous mid-coat paint composition was air-sprayer painted in such a way as to provide a dry film thickness of 25 μm and, after being left to stand for 7 minutes at room temperature, it was flashed off for 3 minutes at 80° C. in an electric hot draught drier and then baked for 30 minutes at 140° C. The hardness of the paint film obtained was measured using the pencil scratch test method (JIS-K5400) and evaluated in the following way.

◯: F or above

### Δ: B to 2B

X: Less than 3B

### [Potential for Industrial Use]

The aqueous mid-coat paint compositions of this invention can be used as mid-coat paint compositions in various applications and they are especially useful as mid-coat paint compositions for automobile purposes.

1. An aqueous mid-coat paint composition, comprising
(A) a water-soluble or water-dispersible polyester resin, comprising
carboxylic acid groups,
from 2 to 10 mass % of linear chain or branched chain polyethylene glycol groups or polyethylene glycol ether groups comprising a number average molecular weight of from 300 to 600,
carboxylic acid secondary amine salt groups or carboxylic acid tertiary amine salt groups obtained by neutralizing at least some of the carboxylic acid groups in the resin,
a total number of from 0.8 to 1.2 of said polyethylene glycol groups or polyethylene glycol ether groups and said carboxylic acid secondary or tertiary amine salt groups per number average molecular weight of the resin, and
wherein, before said carboxylic acid groups are neutralized with said secondary or tertiary amine the polyester resin comprises
an acid value of not more than 30 mgKOH/g,
a hydroxyl group value of from 90 to 160 mgKOH/g, and
a number average molecular weight of from 1,300 to 1,900, and
(B) at least one melamine resin as curing agent,
wherein a ratio by mass of the resin solid fractions of the (A) component and the (B) component is from 75/25 to 90/10.

2. The aqueous mid-coat paint composition of claim 1, wherein melamine resin (B) comprises a fully methylated melamine resin and an imino group-containing type methylated melamine resin, and the proportion of said fully methylated melamine resin with respect to the imino group-containing methylated melamine resin as the ratio by mass of the resin solid fractions is from 100/0 to 50/50.

3. The aqueous mid-coat paint composition of claim 1, further comprising polypropylene glycol or polypropylene glycol ether of number average molecular weight from 400 to 1,200 as a (C) component in an amount of from 1 to 20 mass % of the total resin solid fraction.

4. The aqueous mid-coat paint composition of claim 1, further comprising a blocked isocyanate compound as a curing agent in an amount of from 1 to 30 mass % of the total resin solid fraction.
